(19) United States
(12) Patent Application Publication
(10) Pub. No.: US 2009/0135704 A1
(43) Pub. Date: May 28, 2009

(54) RETAINING BODY AND THE LIKE

(75) Inventors: Hiroyuki Watanabe, Saitama (JP); Eiji Kuroki, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/295,601

(22) PCT Filed: Mar. 13, 2007
(86) PCT No.: PCT/JP2007/054951

§ 371 Date: Sep. 30, 2008

(30) Foreign Application Priority Data
Mar. 31, 2006 (JP) 2006-098086

(51) Int. Cl. G11B 7/00; G02B 5/18

(52) U.S. Cl. 369/109.01; 359/566; G9B/7

(57) ABSTRACT

The present invention provides a retaining body and the like which adjust a diffraction state of a laser beam using a simple configuration.

The retaining body of the invention is a retaining body 15 of a diffraction grating 41 attached to a base 2 of an optical pickup P. The retaining body 15 includes a main body 16, first retaining means 15a which retains a diffraction grating 41 while the diffraction grating 41 is rotatable with respect to the main body 16, second retaining means 17, 19 which retain the main body 16 while the main body 16 is rotatable with respect to base 2, and main body moving means 18, 18a which are used to move the main body 16 with respect to the base 2.

### TECHNICAL FIELD

The present invention relates to a retaining body and the like which movably retain a diffraction grating disposed in an optical pickup.

### BACKGROUND ART

Conventionally, there is known an information recording and reproducing apparatus which records in and reproduces an optical medium pursuant to a standard such as CD (Compact Disc) and DVD (Digital Versatile Disc).

The information recording and reproducing apparatus includes the optical pickup, and the optical pickup includes a Laser Diode (hereinafter abbreviated to “LD”) which emits a laser beam to the optical medium and a light acceptance element which accepts light reflected from the optical medium. The information recording and reproducing apparatus irradiates the optical medium with the laser beam and collects the laser beam, and the information recording and reproducing apparatus accepts the laser beam reflected from the optical medium, thereby recording information in the optical medium or reading the information from the optical medium to perform the reproduction.

In the optical pickup, the diffraction grating which diffracts the laser beam is disposed on an optical path of the laser beam, the diffraction grating is attached by a holder while being turnable about an axis of the laser beam, and a diffraction state of the laser beam can be adjusted by turning the diffraction grating. The holder is fixed to a base.

In general, in an optical pickup producing process, the holder is attached to a position previously defined according to component accuracy while fixed by a bonding agent, and the position of the diffraction grating which is movable with respect to the base is not adjusted.

### DISCLOSURE OF THE INVENTION

### Problem to be Solved by the Invention

However, in order to obtain the good diffraction state, there is a need for aligning the laser beam with the center of the diffraction grating.

Recently, in order that the optical pickup is compatible with the optical medium such as DVD-RAM, there is generated a need for finely adjusting the position, at which the optical medium is irradiated with the laser beam, in a radial direction of the optical medium.

In order to solve the above problem, it is an object of the invention to provide a retaining body and the like which adjust the diffraction state of the laser beam using a simple structure.

### Means for Solving the Problem

In order to solve the above problem, the invention of claim 1 relates to a retaining body (15) for a diffraction grating (41) attached to a base (2) of an optical pickup (P),

the retaining body, comprising:

a main body (16);

first retaining means (15a) for retaining the diffraction grating while the diffraction grating is rotatable with respect to the main body;

second retaining means (17, 19) for retaining the main body while the main body is movable with respect to the base; and

main-body moving means (18, 18a) used for moving the main body with respect to the base.

In order to solve the above problem, the invention of claim 3 relates to a pickup device, comprising the retaining body according or claim 1 or 2.

In order to solve the above problem, the invention of claim 4 relates to a diffraction grating position adjusting method of adjusting a position of a diffraction grating with respect to a laser beam using the retaining body according to claim 1,

the diffraction grating position adjusting method, comprising:

a diffraction grating moving process of moving the main body with respect to a base; and

a diffraction grating rotating process of rotating the diffraction grating.

### BRIEF DESCRIPTION OF DRAWINGS

FIG. 1 is a structural drawing schematically showing an optical pickup.

FIG. 2 is a sectional view showing a state in which a diffraction grating is attached to a space portion.

FIGS. 3A and 3B show a structure of a retaining body, FIG. 3A is a perspective view showing a front face of the retaining body, and FIG. 3B is a perspective view showing a backside of the retaining body.

FIGS. 4A and 4B show a structure of the diffraction grating, FIG. 4A is a perspective view showing a front face of the diffraction grating, and FIG. 4B is a perspective view showing a backside of the diffraction grating.

FIGS. 5A and 5B show a state in which the diffraction grating is assembled in the retaining body, FIG. 5A is a perspective view showing a front face of the assembly, and FIG. 5B is a perspective view showing a backside of the assembly.

FIG. 6 is an explanatory view in adjusting a position of the diffraction grating.

FIG. 7 is a structural drawing showing another embodiment of the retaining body.

### EXPLANATIONS OF LETTERS OR NUMERALS

P optical pickup
2 base
15 retaining body
15a opening
16 main body
18 lower-portion inwardly bending piece
18a groove portion
19 lower-portion outwardly bending piece
40 diffraction grating ASSY
41 diffraction grating

### BEST MODE FOR CARRYING OUT THE INVENTION

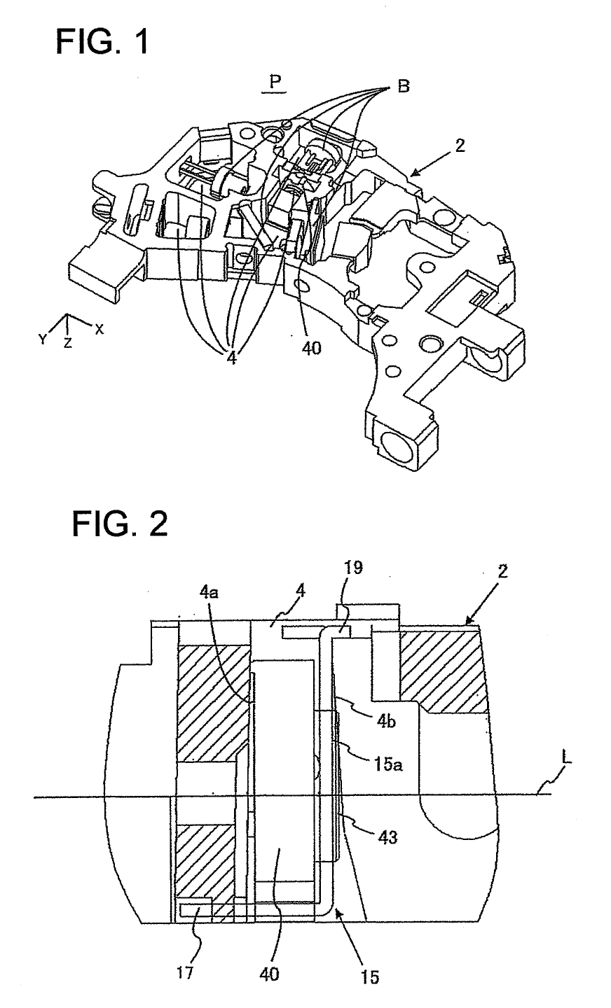

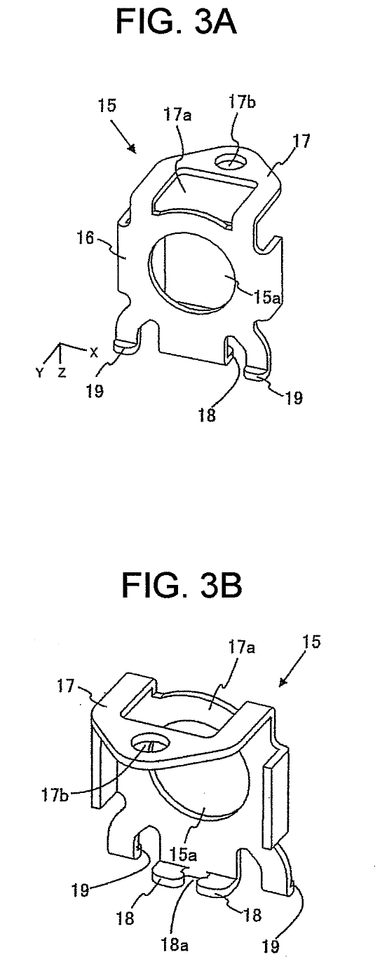

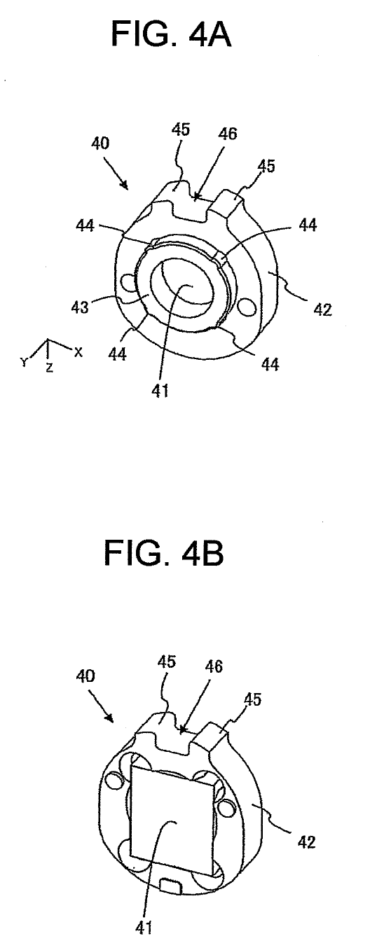

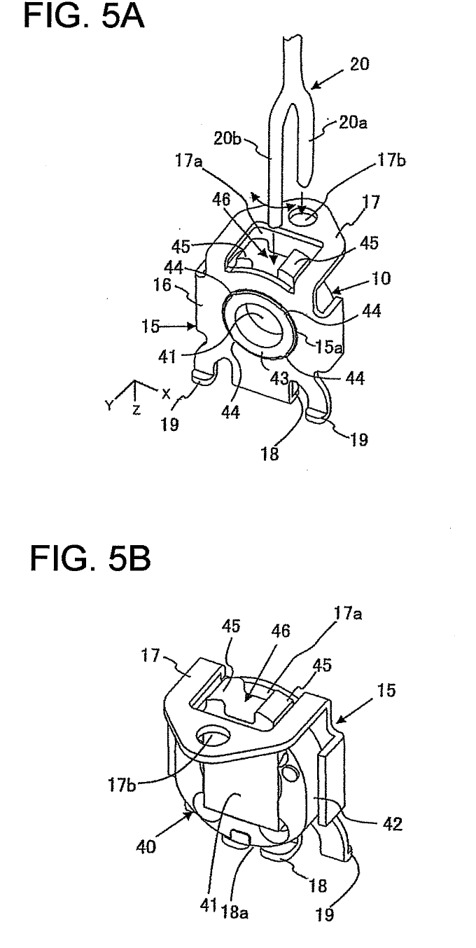

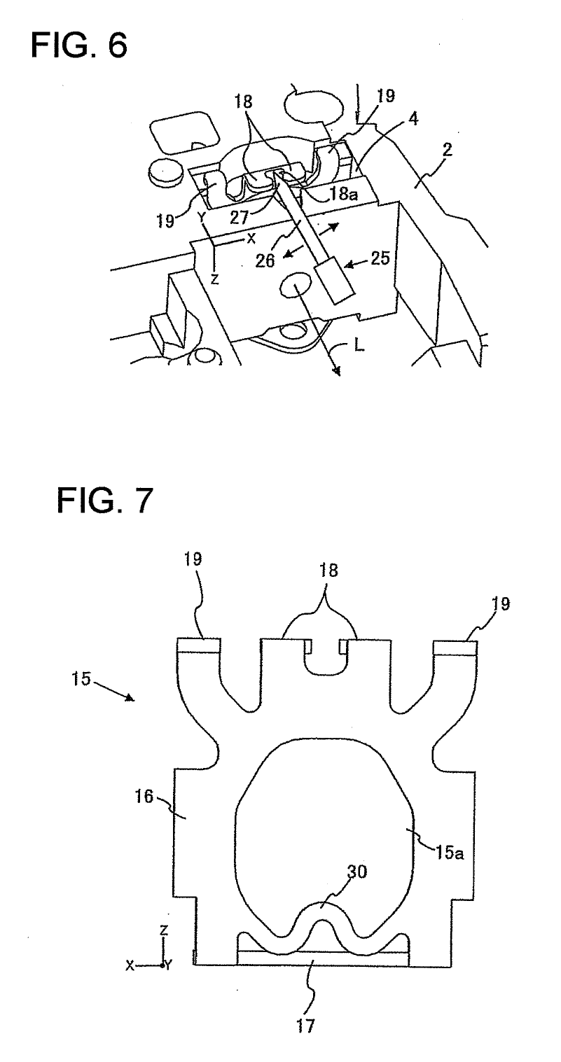

The best mode of the present invention will be described in detail below with reference to FIGS. 1 to 7. FIG. 1 is a structural drawing schematically showing an optical pickup, FIG. 2 is a sectional view showing a state in which a diffraction grating is attached to a space portion, FIGS. 3A and 3B show a structural drawing of a retaining body, FIGS. 4A and 4B show a structural drawing of the diffraction grating, FIGS. 5A and 5B show a state in which the diffraction grating is assembled in the retaining body, FIG. 6 is an explanatory view in adjusting a position of the diffraction grating, and FIG. 7 is a structural drawing showing another embodiment of the retaining body. For the sake of easy understanding, vertical and horizontal directions are expressed by X, Y, and Z directions in the drawings. However, orientations of components are not limited to the drawings.

A retaining body 15 according to an embodiment of the invention is disposed in an optical pickup P of the information recording and reproducing apparatus which records in and reproduces the optical medium pursuant to the standard such as CD and DVD. Specifically, the retaining body 15 is used when a diffraction grating 41 disposed on an optical path of the laser beam emitted from the optical pickup P is attached to the base 2 of the optical pickup P.

—Configuration and the like of Optical Pickup—

The optical pickup P includes components B. The components B include LD which emits the laser beam, the diffraction grating which diffracts the laser beam, a polarization beam splitter which polarizes the laser beam, a collimator lens which adjusts parallelism of the laser beam, an objective lens which collects the laser beam to irradiates the optical medium with the laser beam, and a light acceptance element which accepts light reflected from the optical medium. As shown in FIG. 1, the components B are attached to the base 2.

A space portion 4 is formed in the base 2 to attach the components B, and each of the components B is attached to a previously-defined position of the space portion 4. An optical path through which the laser beam emitted from LD passes is formed in the base 2, and the components B are disposed on the optical path.

As shown in FIG. 2, a diffraction grating ASSY 40 which retains the diffraction grating 41 is disposed in a position of the space portion 4 by a retaining body 15 while being urged against a wall surface 4a (base 2) constituting the space portion 4. The diffraction grating ASSY 40 is disposed on an optical path L of the laser beam and in a direction perpendicular to an axial line of the laser beam, and the laser beam passes through the diffraction grating 41.

As shown in FIGS. 3A and 3B, the retaining body 15 includes a main body 16 having an opening 15a in a central portion thereof. The main body 16 is made of a plate-shape metal material having elasticity, and the diffraction grating ASSY 40 is urged against the base 2 by the elasticity. The main body 16 includes an upper-portion bending piece 17, a lower-portion inwardly bending piece 18, and a lower-portion outwardly bending piece 19. The upper-portion bending piece 17 is formed while an upper portion thereof is bent. The lower-portion inwardly bending piece 18 and the lower-portion outwardly bending piece 19 are formed while the lower portions are bent in opposed directions. Two openings 17a and 17b are continuously formed in the upper-portion bending piece 17. A tool inserting groove portion 18a is formed in the lower-portion inwardly bending piece 18.

As shown in FIG. 2, in the retaining body 15, the upper-portion bending piece 17 is disposed in a lower side of the space portion 4, the main body 16 is disposed in the space portion 4, and the lower-portion outwardly bending piece 19 is attached to a wall surface 4b constituting the space portion 4 while being engaged with an upper portion of the wall surface 4b. The lower-portion outwardly bending piece 19 is attached to the wall surface 4b while being engaged with the upper portion of the wall surface 4b, and the main body 16 is retained by an elastic force of the retaining body 15 while being movable in a horizontal direction with respect to the base 2 (X direction in FIG. 1).

On the other hand, as shown in FIGS. 4A and 4B, the diffraction grating ASSY 40 includes the diffraction grating 41 through which the laser beam passes and a holder 42. The diffraction grating 41 is fixed by the substantially annular holder 42 provided in an outer circumferential edge. A section of the holder 42 is formed in a flange shape such that the holder has a cylindrical projection portion 43 in a central portion thereof. Plural protrusions 44 are provided in an outer circumferential portion of the projection portion 43, and the protrusions 44 are protruded at predetermined intervals in a circumferential direction. A tool inserting recess 46 formed by a pair of protrusions 45 is formed in an upper portion of the holder 42.

The retaining body 15 as shown above and the diffraction grating ASSY 40 are disposed in the space portion 4 while being combined as shown in FIGS. 5A and 5B. Specifically, the projection portion 43 of the diffraction grating ASSY 40 is fitted in the opening 15a of the retaining body 15, and the diffraction grating ASSY 40 is tightly fitted by the protrusion 44 of the diffraction grating ASSY 40 while a shift is not generated with respect to the opening 15a of the retaining body 15. The tool inserting recess 46 faces the opening 17a of the upper-portion bending piece 17.

When the retaining body 15 and the diffraction grating ASSY 40 are disposed in the space portion 4, the retaining body 15 and diffraction grating ASSY 40 shown in FIGS. 5A and 5B are disposed upside-down, as shown in FIG. 2.

The optical pickup P of the embodiment constitutes the optical pickup device of the invention, and the opening 15a of the embodiment constitutes the first retaining means of the invention. The lower-portion outwardly bending piece 19 of the embodiment constitutes the second retaining means of the invention, and the lower-portion inwardly bending piece 18 and groove portion 18a of the embodiment constitutes the main-body moving means of the invention.

—Positional Adjustment of Diffraction Grating—

The positional adjustment of the diffraction grating will be described below.

With regard to the diffraction grating ASSY 40 turnably retained in the space portion 4 by the retaining body 15, the position of the diffraction grating ASSY 40 to which the diffraction grating 41 is fixed is adjusted such that the good diffraction state is obtained in a process of producing the optical pickup P.

In the case where the diffraction grating ASSY 40 is rotated to adjust the diffraction state of the laser beam to a good state, for example, the position of the diffraction grating ASSY 40 is adjusted using a tool 20 whose leading tip is formed in a U-shape as shown in FIGS. 5A and 5B. Specifically, a leading tip 20a of the tool 20 is inserted into the opening 17b formed in the upper-portion bending piece 17, a leading tip 20b is inserted into the opening 17a, the leading tip 20b is pressed against the tool inserting recess 46, and the leading tip 20b is rotated about the leading tip 20a.

Therefore, because the work of rotating the leading tip 20b is stably performed, fine adjustment of a rotational angle of the diffraction grating ASSY 40 is easily performed when the diffraction grating is rotated to obtain the good diffraction state of the laser beam. Alternatively, using a tool such as a screwdriver, the leading tip of the tool is pressed against the tool inserting recess 46 to apply a force to one of the pair of protrusions 45 constituting the tool inserting recess 46, and the diffraction grating ASSY 40 may be rotated.

In the case where the diffraction grating ASSY 40 is moved in the horizontal direction with respect to the base 2 in order to align the laser beam with a proper position (for example, the center) of the diffraction grating 41 of the diffraction grating ASSY 40, for example, a main body 26 of a tool 25 is disposed in the groove portion 2a of the base 2, which is formed while facing the tool inserting groove portion 18a, a leading tip 27 of the tool 25 is disposed in the tool inserting groove portion 18a, and a force is applied to one of the right and left of the lower-portion inwardly bending piece 18 by the leading tip 27 of the tool 25 while the groove portion 2a of the base 2 is used as a fulcrum, thereby moving the main body 16 of the retaining body 15.

Therefore, because the work for applying the force to one of the right and left of the lower-portion inwardly bending piece 18 with the leading tip of the tool 25 is stably performed, the fine adjustment of a moving amount of the main body 16 of the retaining body 15 is easily performed when the retaining body 15 is horizontally moved relative to the base 2 to align the laser beam with the center of the diffraction grating 41. Alternatively, using a tool such as the screwdriver, the leading tip of the tool is inserted in the tool inserting groove portion 18a to apply a force to one of the right and left of the lower-portion inwardly bending piece 18, and the retaining body 15 may be horizontally moved with respect to the base 2.

Thus, in the state in which the diffraction grating ASSY 40 is urged against the base 2 of the optical pickup P, the diffraction grating ASSY 40 is turnably retained by the retaining body 15 so as to be perpendicular to the optical axis direction of the laser beam, and the main body 16 of the retaining body 15 is retained by the elastic force of the retaining body 15 and the lower-portion outwardly bending piece 19 while being horizontally movable with respect to the base 2. The main body 16 of the retaining body 15 can be horizontally moved with respect to the base 2 using the lower-portion inwardly bending piece 18 and the groove portion 18a.

Therefore, the rotational angle of the diffraction grating ASSY 40 can be adjusted such that the diffraction grating ASSY 40 is rotated to obtain the good diffraction state of the laser beam while being attached to the base 2, and the position of the diffraction grating ASSY 40 can be adjusted such that the diffraction grating ASSY 40 is horizontally moved with respect to the base 2 to align the laser beam with the center of the diffraction grating 41 of the diffraction grating ASSY 40.

Another embodiment of the retaining body will be described below.

As shown in FIG. 7, the lower portion of the opening 15a of the retaining body 15 may be curved upward to form a projection portion 30 projected from the lower portion of the opening 15a toward the upper portion of inside (center direction).

Therefore, when the diffraction grating ASSY 40 is attached to the retaining body 15, because the projection portion 43 of the diffraction grating ASSY 40 is urged toward the center direction of the opening 15a by the projection portion 30 formed in the lower portion of the opening 15a of the retaining body 15, the diffraction grating ASSY 40 is attached to the opening 15a of the retaining body 15 in a rattle-free manner.

When the diffraction grating ASSY 40 is attached to the retaining body 15, the projection portion 43 of the diffraction grating ASSY 40 is inserted in and attached to the opening 15a of the retaining body 15 while the projection portion 30 formed in the opening 15a of the retaining body 15 is bent downward.

The embodiment is described only by way of example, and the invention is not limited to the embodiment. For example, the projection portion 30 is not always provided in the lower portion of the opening 15a, but it is only necessary to urge the projection portion 43 of the diffraction grating ASSY 40 toward the center direction of the opening 15a when the diffraction grating ASSY 40 is attached to the retaining body 15.

1-4. (canceled)

5. A retaining body for a diffraction grating attached to a base of an optical pickup,
the retaining body, comprising:
a main body disposed on an optical path of laser beam emitted by the optical pickup;
the main body being formed to includes:
an opening portion as a first retaining unit which rotatably retains the diffraction grating;
a second retaining unit which is engaged with the base, and moves the main body in a direction perpendicular to the optical path; and
a groove portion which is engaged with a tool which moves the main body.

6. The retaining body according to claim 5,
wherein a projection portion is formed at the opening portion;
the projection portion urging the diffraction grating toward a central direction of the diffraction grating while the diffraction grating is retained by the main body.

7. The retaining body according to claim 6,
wherein the opening portion is formed at the center of the main body of plate shape;
the second retaining unit includes an upper-portion bending piece which is formed by bending an upper portion of the main body, a lower-portion outwardly bending piece which is formed by bending a lower portion of the main body in a direction opposite to that of the upper-portion bending piece, and a lower-portion inwardly bending piece;
the groove portion is formed at the inward-portion inwardly bending piece; and
the retaining body is attached in such a manner that the upper-portion bending piece is disposed at a lower portion of one wall surface which forms a space portion formed in the base, and the upper-portion outwardly bending piece is engaged with an upper portion of the other wall surface which forms the space portion formed in the base.

8. A pickup device, comprising the retaining body according or claim 7,
wherein the diffraction grating comprises a lens through which a laser beam passes, and a holder which is provided on the outer periphery of the lens, and has a cylindrical projection portion formed at the center thereof;
a tool inserting recess which is composed of a pair of protrusions is formed at an upper portion of the holder; and
the diffraction grating is positioned in such a manner that the projection portion is fitted in the opening portion, and the tool inserting recess faces the upper-portion bending piece.

9. A diffraction grating position adjusting method of adjusting a position of a diffraction grating with respect to a laser beam in a pickup device according to claim 8,
the diffraction grating position adjusting method, comprising:
a diffraction grating moving process of engaging a tool with the groove portion, pushing one of the left and right wall surfaces of the groove portion, and moving the main body in a direction perpendicular to the optical path; and
a diffraction grating rotating process of engaging a tool with the tool inserting recess, pushing one of a pair of protrusions, and rotating the diffraction grating.
